(19) United States
(12) Patent Application Publication
(10) Pub. No.: US 2025/0266632 A1
(43) Pub. Date: Aug. 21, 2025

(54) Hybrid Hose For Transmission of Fluid, Electrical Power and Data Communication

(71) Applicant: Louisiana Tech Research Corporation, Ruston, LA (US)

(72) Inventors: Arun Prakash Jaganathan, Monroe, LA (US); Anthony Winiewicz, Orlando, FL (US)

(21) Appl. No.: 18/444,237

(22) Filed: Feb. 16, 2024

(51) Int. Cl. H01R 13/00; B23B 39/10; F16L 55/26; F16L 101/30

(52) U.S. Cl. CPC H01R 13/005; B23B 39/10; F16L 55/26; B23B 2270/022; B23B 2270/027; F16L 2101/30

(57) ABSTRACT

A hybrid hose assembly capable of transmitting fluid, electrical power, and data communications through a single hose assembly is disclosed. By providing the transmission of fluid power, electrical power, and bidirectional communication between the source and destination units connected thereto, the hybrid hose of the present invention can enhance functional capabilities of fluid-powered equipment used in harsh environments, such as subsea operations, aviation, and trenchless applications. A hybrid hose assembly embodying features of the present invention may comprise a hybrid hose having a fluid tube surrounded by at least two conductive metallic braided layers adapted to transmit electrical power and data communications, an electro-fluid hose fitting coupled to the hybrid hose, and an overmold encapsulating at least a portion of the electro-fluid hose fitting.

### RELATED APPLICATIONS

This application claims priority to U.S. Provisional Application No. 63/446,566, filed Feb. 17, 2023, which is hereby incorporated by reference.

### BACKGROUND

Hydraulic and pneumatic equipment is widely used in a variety of industries including construction, automotive, aviation, manufacturing, and shipping. The power to these machines is supplied by pressurized fluid pumped through specially designed fluid power hoses. Fluid power hoses can be rated to handle pressures in thousands of pounds-per-square-inch (psi) and constitute a critical component of the overall systems in which they are employed. These hoses come in variety of forms and sizes depending on the application, and they are typically reinforced with either non-metallic or metallic braid layers depending upon their pressure rating. For example, for pressures less than 1,000 psi, only a few layers of textile braids are used for reinforcement, while for higher pressures, up to six layers of metallic braids are used. The metallic braids are commonly made of stainless steel, but steel, brass, aluminum, etc. can also be used.

A typical fluid power hose for high-pressure applications consists of an inner tube, multiple layers of metallic reinforcement braids layered between separation layers, and an external protective covering. Depending on the needs of the application, the internal tube is typically made of rubber, Teflon, or nylon. The external protective covering is typically a polymeric material, such as synthetic rubber or polyurethane.

Many hydraulic and pneumatic systems also employ electrical devices near the ends of the hoses. In these applications, providing power and communication to these electrical devices requires an additional cable dedicated to electrical transmission to be routed along with the fluid power hose. In many instances, the additional cable is either unwelcome due to increased cost and complexity or impractical due to the severity of the environment in which the hose is employed, particularly in trenchless applications, as electrical cables are typically not robust enough to handle the high mechanical loads expected in hydraulic and pneumatic equipment.

For example, steering a conventional impact mole (i.e., a pneumatic ground-piercing tool) used in trenchless technology, such as for laying pipes or cables underground, presents a unique challenge because the mole operates underground and out of direct visual range. Unlike more advanced directional drilling equipment that can be steered in real-time (e.g., horizontal directional drilling (HDD) systems), impact moles have a more rudimentary steering capability that requires the operator to set the angle and direction of the mole accurately according to the planned trajectory at the start of the bore. While it would be desirable to have the capability to electronically control the direction of the impact mole by establishing a communication link with the tool to transmit data from sensors and actuators, the underground environment has made it impractical to run a separate electric cable along with the fluid power hose.

Even in applications where it is feasible to run a separate electric cable along with the fluid power hose, hose/cable combinations add complexity and cable management issues to projects. For example, robotic devices that operate remotely inside underground pipelines and sewers tend to require pneumatic or hydraulic power in addition to electrical, video, data, and command/control communications. Examples include lateral reinstatement cutters, chemical grouting, cured-in-place piping, and jetter cleaning. Current systems employ a separate dedicated cable to power a camera and bring back a video signal; however, these systems have been plagued with cable management issues that come with deploying two cables/hoses into the sewer simultaneously from two reels.

### SUMMARY

Disclosed herein is a novel hybrid hose assembly capable of transmitting fluid, electrical power, and data communications through a single hose assembly. By providing the transmission of fluid power, electrical power, and bidirectional communication between the source and destination units connected thereto, the hybrid hose of the present invention can enhance functional capabilities of fluid-powered equipment used in harsh environments, such as subsea operations, aviation, and trenchless applications.

A hybrid hose assembly embodying features of the present invention may comprise a hybrid hose having a fluid tube surrounded by at least two conductive metallic braided layers adapted to transmit electrical power and data communications, an electro-fluid hose fitting coupled to the hybrid hose, and an overmold encapsulating at least a portion of the electro-fluid hose fitting. An insulating layer is disposed between the first and second braid layers, with a protective jacket disposed around the second braid layer. The electro-fluid hose fitting may include a main body, a crimp collar, and at least two contact bands having bonded wires adapted to create electrical connections with the first and second metallic braid layers. The bonded wire of the first contact band is electrically connected to the first braid layer through the crimp collar, while the bonded wire of the second braid contact band is directly connected to the second braid layer. The overmold preferably covers at least the contact bands of the electro-fluid hose fitting.

In another embodiment employing the inventive concepts of the present invention, the hybrid hose may comprise at least four conductive metallic braided layers adapted to transmit electrical power and data communications. In such embodiments, the electro-fluid hose fitting features four contact bands each having a bonded wire adapted to be coupled to the four conductive metallic braided layers.

In another aspect of the invention, a trenchless boring method is disclosed that utilizes the novel hybrid hose assembly. The trenchless boring method may comprise utilizing a boring system comprising a boring head, a surface controller, and a hybrid hose assembly. The boring head can include a steering actuator and a displacement sensor. The surface controller is configured to transmit steering signals to the steering actuator and receive location signals from the displacement sensor. The hybrid hose assembly comprises a fluid tube, at least two layers of conductive, metallic reinforcement braids, an insulating layer separating the conductive braids, and a protective jacket. The fluid tube is configured to transmit fluid power to the boring head, while the conductive braids are configured to transmit electric power to the steering actuator and location signals to the surface controller. The foregoing boring system may be utilized by positioning the boring head in a subterranean bore; transmitting steering signals from the surface controller to the steering actuator, through the hybrid hose assembly to drive the boring head along an intended path; and receiving location signals at the surface controller in order to determine whether the boring head is progressing along the intended path.

In another aspect of the invention, a trenchless pipeline inspection and rehabilitation method is disclosed that utilizes the novel hybrid hose assembly. The trenchless pipeline inspection and rehabilitation method may comprise utilizing a robotic crawler system comprising a robotic crawler, a surface controller, and a hybrid hose assembly. The robotic crawler includes a camera orientation actuator, a camera, and a hydraulic or pneumatic peripheral tool. The surface controller is configured to transmit command signals to the camera orientation actuator, receive and display video feed from the camera, and operate the peripheral tool. The hybrid hose assembly comprises a fluid tube, at least two layers of conductive, metallic reinforcement braids, an insulating layer separating the conductive braids, and a protective jacket. The fluid tube is configured to transmit fluid power to the peripheral tool, and the conductive braids are configured to transmit electric power to the camera and the camera orientation actuator, video feed to the surface controller, and command signals to the peripheral tool. The foregoing robotic crawler system may be utilized by positioning the robotic crawler in a subterranean pipeline; transmitting command signals from the surface controller to the camera orientation actuator through the hybrid hose assembly, in order to pan, tilt, zoom, adjust camera settings, adjust lighting, start and stop recording, or control any other camera operations; transmitting command signals from the surface controller to the peripheral tool; and receiving video feed at the surface controller in order to visually inspect the pipeline for damage and to monitor repair progress.

The above summary is not intended to describe each illustrated embodiment or every possible implementation. These and other features, aspects, and advantages of the present invention will become better understood with regard to the following description, appended claims, and accompanying drawings.

### BRIEF DESCRIPTION OF THE DRAWINGS

The accompanying figures, where like reference numerals refer to identical or functionally similar elements throughout the separate views, which are not true to scale, and which, together with the detailed description below, are incorporated in and form part of the specification, serve to illustrate further various embodiments and to explain various principles and advantages in accordance with the present invention:

FIG. 1 is a perspective view of an embodiment of a hybrid hose assembly employing features of the present invention.

FIG. 2 is a perspective view of the hybrid hose assembly depicted in FIG. 1 with the overmold removed.

FIG. 3 is an exploded view of the hybrid hose assembly depicted in FIG. 1.

FIGS. 4A and 4B are perspective views of an embodiment of an electrical insulator suitable for usage with the hybrid hose assembly depicted in FIG. 1.

FIG. 5 is a sectional view of the hybrid hose assembly depicted in FIG. 1.

FIG. 6 is a perspective view of the hybrid hose assembly depicted in FIG. 1 with additional conductive elements.

FIG. 7 is a perspective view of the hybrid hose assembly depicted in FIG. 6 with the overmold removed.

FIG. 8 is a sectional view of the hybrid hose assembly depicted in FIG. 6.

FIG. 9 is a perspective view of an alternative embodiment of a hybrid hose assembly employing features of the present invention.

FIG. 10 is an exploded view of the hybrid hose assembly depicted in FIG. 9.

FIG. 11A is a perspective view of an embodiment of an electrical insulator suitable for usage with the hybrid hose assembly depicted in FIG. 9.

FIG. 11B is a sectional view of an embodiment of an electrical insulator suitable for usage with the hybrid hose assembly depicted in FIG. 9.

FIG. 12 is a perspective view of the hybrid hose assembly depicted in FIG. 9 with the overmold removed.

FIG. 13 is a perspective view of a hose fitting suitable for usage with the hybrid hose assembly depicted in FIG. 9.

FIG. 14 is a sectional view of the hybrid hose assembly depicted in FIG. 9.

FIG. 15 is a perspective view of another alternative embodiment of a hybrid hose assembly employing features of the present invention.

FIG. 16 is a perspective view of the hybrid hose assembly depicted in FIG. 15 with the overmold removed.

FIG. 17 is a sectional view of the hybrid hose assembly depicted in FIG. 15.

FIG. 18 is a flow diagram depicting a process by which a hybrid hose assembly employing features of the present invention may transmit electrical signals between computing devices located at each end of the hybrid hose assembly.

FIG. 19 is a diagram depicting a hybrid hose assembly employing features of the present invention being utilized in a trenchless application.

FIG. 20 is a diagram depicting a hybrid hose assembly employing features of the present invention being utilized to connect a surface controller to a submersible robotic crawler system in order to conduct a sewer inspection and rehabilitation.

### DETAILED DESCRIPTION

Detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Alternate embodiments may be devised without departing from the spirit or the scope of the invention. Further, the terms and phrases used herein are not intended to be limiting; but rather, to provide an understandable description of the invention. While the specification concludes with claims defining the features of the invention that are regarded as novel, it is believed that the invention will be better understood from a consideration of the following description in conjunction with the drawing figures, in which like reference numerals are carried forward.

As used herein, the terms “a” or “an” are defined as one or more than one. The term “plurality,” as used herein, is defined as two or more than two. The term “another,” as used herein, is defined as at least a second or more. The terms “comprises,” “comprising,” or any other variation thereof are intended to cover a non-exclusive inclusion, such that a process, method, article, or apparatus that comprises a list of elements does not include only those elements, but may include, other elements not expressly listed or inherent to such process, method, article, or apparatus. An element proceeded by “comprises” does not, without more constraints, preclude the existence of additional identical elements in the process, method, article, or apparatus that comprises the element. The terms “including,” “having,” or “featuring,” as used herein, are defined as comprising (i.e., open language). The term “coupled,” as used herein, is defined as connected, although not necessarily directly, and not necessarily mechanically. As used herein, the term “about” or “approximately” applies to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure. Relational terms such as first and second, top and bottom, right and left, and the like may be used solely to distinguish one entity or action from another entity or action without necessarily requiring or implying any actual such relationship or order between such entities or actions.

The hybrid hose assembly of the present invention comprises (1) a hydraulic or pneumatic hose comprising conductive elements incorporated into the hose and configured to allow the flow of data, electricity, and fluid through the hose and (2) a hose fitting on each end of the hose configured to transmit the data, electricity, and fluid to and from the hose. This hybrid hose assembly acts not only as a robust conduit to transport hydraulic or pneumatic fluid, but also serves as an electrical transmission line for establishing a communication link between peripheral devices located at either ends of the hose. In addition to these modulated communication signals, electrical power (AC or DC) is also sent through the hose to power actuators, sensors, and other devices connected to the hose. A transformer-based coupling circuit is used to isolate the low frequency (50 or 60 Hz) power signals from damaging circuitry that is used to transmit the high frequency data communication signals (in the range of kHz to several MHz). Thus, the hose serves three functions: transmission of mechanical power, transmission of electrical power, and bidirectional communication between the source and peripheral devices connected to it.

In applications where only low amounts and quality of data are needed, a low to medium bandwidth communication link may be established through the hose using standard narrow bandwidth telecommunication protocols such as Frequency Shift Keying (FSK), Orthogonal Frequency-Division Multiplexing (OFDM), etc. In applications where high amounts and quality of data are required, a high bandwidth communication link may be established through the hose using a standard high data rate communication method such as Gigabit Home Networking (G.hn). Experiments conducted using G.hn protocols and modulation techniques with the hybrid hose designs discussed herein demonstrated data rates on the order of 200 Mbps, which enables transmission of Ultra High-Definition video and sophisticated remote control of tools and equipment. In addition, such high data rates of bidirectional communication enable processing of high bandwidth information such as ground penetrating radar and sonar. Utilization of powerful computers on the surface can enable rapid processing and subsequent closed loop control of advanced sensors and systems downhole, which would not be possible without a high bandwidth data link.

Additionally, the transmission of data signals through the hybrid hose assembly may be used to monitor the health of the hose itself. For instance, a frequency sweep can be carried out and the power received through the hose can be recorded, and then any variations observed in future sweeps would indicate an anomaly in the hose. Once an anomaly is detected, other sophisticated sensor techniques that are used for cable fault location (e.g., time domain and frequency domain reflectometry) can be applied to the hose to enhance the reliability. Thus, the operator could be warned of an impending failure before it happens and utilize preventative maintenance measures to either reinforce or repair the hose in a weak location or entirely replace the hose before it fails. This prevents loss of production time, prevents environmental contamination, and lowers the risk of a safety hazard. One skilled in the art can easily imagine the multitude of applications in which the ability to monitor the health of the hose is critically important.

As stated above, the hybrid hose assembly of the present invention may comprise (1) a hydraulic or pneumatic hose comprising conductive elements incorporated into the hose and configured to allow the flow of data, electricity, and fluid through the hose and (2) a hose fitting on each end of the hose configured to transmit the data, electricity, and fluid to and from the hose. The hose must comprise at least two conductive elements—one for grounding, and one for transmission of data and electrical signals. Using more conductive elements significantly increases the data rate possible because of the availability of parallel conductors to transmit multiple data-carrying signals simultaneously in both directions of the hose. Modern PLC communication modulation schemes utilize three or more conductors to enable multiple-input-multiple-output (MIMO) transmission, as opposed to the single-input-single-output (SISO) transmission possible when only two conductors are used. The use of MIMO technology increases data rates and signaling distance of the conductive elements of the hose.

The conductive elements may comprise wires embedded into the body of the hose, or the reinforcing metallic braid layers already used in high-pressure hoses may act as the conductors through which the electrical signals are transmitted. The metallic braid layers may be formed of steel, copper, aluminum, or any other conductive metal, or a composite of multiple materials. In other embodiments, one conductive metallic braid layer may also serve a structural function, while the additional, non-structural layers are formed of lighter conductive materials. This would allow the use of multiple braid layers to provide high rates of data transmission without significantly increasing the weight of the hose for applications that do not need several layers of reinforcing braids. Further, in embodiments where the conductive elements are embedded wires, any required reinforcing braid layers need not be metallic at all and may instead be formed of plastics or strong textile materials in order to optimize for applications where lighter and/or thinner hoses are required.

The description which follows, and the embodiments described therein, is provided by way of illustration of examples of particular embodiments of principles and aspects of the present invention. These examples are provided for the purposes of explanation—and not of limitation—of those principles of the invention.

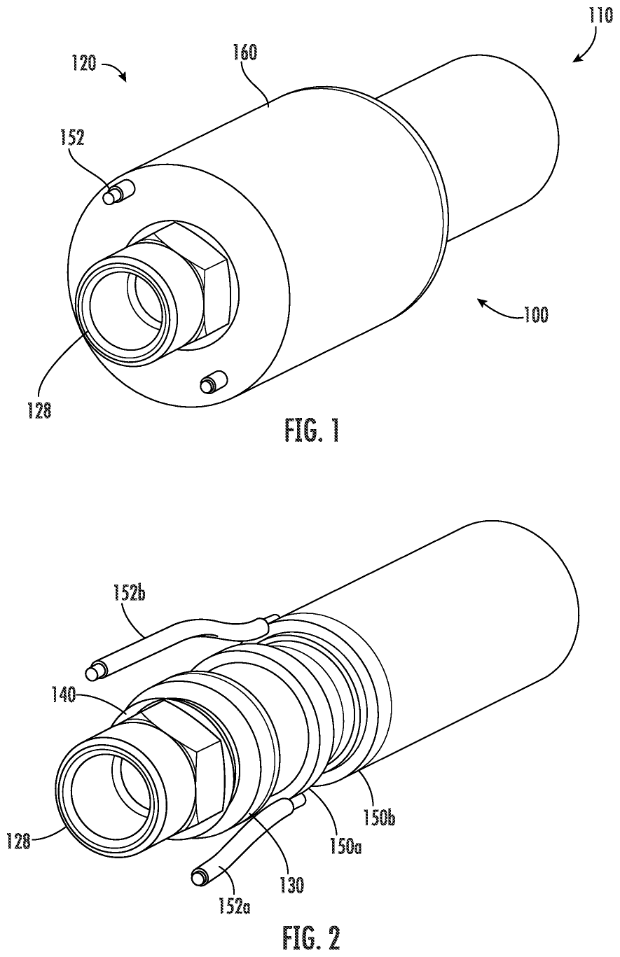

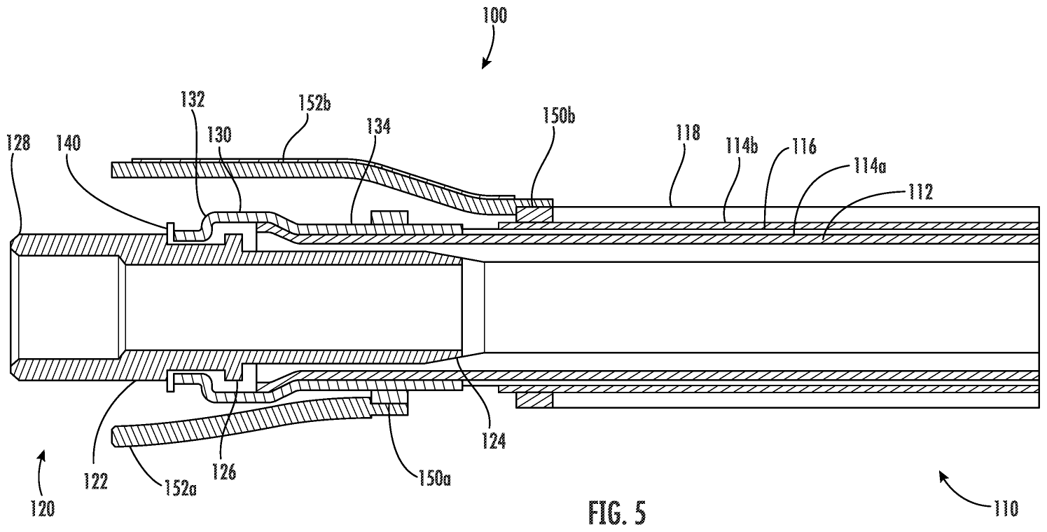

Viewing FIGS. 1-8, in a first exemplary embodiment of the hybrid hose assembly of the present invention, the hose assembly 100 comprises a hybrid hydraulic or pneumatic hose 110 connected to hose fitting 120. Viewing FIG. 5, the hose 110 comprises a core tube 112, a first layer of conductive metallic braids 114a surrounding the core tube 112, a layer of insulating material 116 surrounding the first conductive braid layer 114a, a second layer of conductive metallic braids 114b surrounding the insulating layer 116, and a protective jacket 118 surrounding the second braid layer 114b. The insulating layer 116 and the second braid layer 114b are shorter than the first braid layer 114a, leaving a portion of first braid layer 114a exposed. In addition, the protective jacket 118 is shorter than the second braid layer 114b, leaving a portion of the second braid layer 114b exposed.

Viewing FIGS. 2-3 and 5, the hose fitting 120 primarily comprises (1) a main fitting body 122 that is generally shaped like a hollow cylinder, (2) a crimp collar 130, (3) insulator 140, and (4) contact bands 150. The fitting body 122 has a tapered end 124 that is inserted into the core tube 112 of the hose 110. The core tube 112 electrically insulates the tapered end 124 of the fitting body 122 from the first metallic braid layer 114a. The fitting body 122 further comprises a working end 128 that serves to complete the hydraulic or pneumatic fluid connection from the core tube 112 to a peripheral device. The working end 128 can be any shape standard to hose fittings for hydraulic and pneumatic hoses. The hose 110 is secured around the tapered end 124 of the hose fitting 120 using a crimp collar 130, which is separated from the metallic fitting body 122 by an electrical insulator 140 wrapped around the fitting body 122. The hose fitting 120 further comprises a retaining boss 126, which secures the electrical insulator 140 in place.

Turning to FIGS. 4a-4b, the electrical insulator 140 can be two c-shaped halves 142 that align to cover the entire circumference of the fitting body 122 when the insulator halves 142 are placed around the fitting body 122, as shown in the Figures, but in other embodiments, the insulator 140 can be a single piece formed of an elastomeric material that can stretch around the fitting body 122 to be put into position. Insulator 140 comprises an internal retention groove 146 into which the retaining boss 126 fits. The insulator 140 further comprises an upper lip 144, which forms an exterior pocket 148 in which the upper portion 132 of the crimp collar 130 sits when crimped over the insulator 140. The upper lip 144 ensures complete separation between the crimp collar 130 and the working end 128 of the fitting 120 (see FIG. 5). The electrical insulator 140 described herein is merely exemplary of the myriad of different methods and materials, both known and developed in the future, which could be used to insulate the crimp collar 130 from the hose fitting 120. The insulator 140 should be made of a material with insulating properties and with a high compressive strength, such as Garolite™ or a phenolic resin, for example.

The use of the electrical insulator 140 to insulate the fitting main body 122 from the crimp collar 130 allows the crimp collar 130 to be used as an electrical conductor. Viewing FIG. 5, an upper portion 132 of the crimp collar 130 is crimped around the electrical insulator 140, while a lower portion 134 of the crimp collar 130 compresses the exposed portion of the first conductive braid layer 114a and the core tube 112 against the fitting body 122, establishing an electrical connection between the first braid layer 114a and the collar 130 while the core tube 112 insulates the lower portion 134 of the crimp collar 130 from the tapered end 124 of the fitting body 122. A first contact band 150a is wrapped around the lower portion 134 of crimp collar 130, and a bonded wire 152a on contact band 150a extends towards the working end 128 of main fitting body 122. A second contact band 150b is wrapped around the exposed portion of the second conductive braid layer 114b. The second contact band 150b also includes an attached bonded wire 152b that extends towards the working end 128 of main fitting body 122. The terminal ends of the bonded wires 152 can be operatively connected to transceiver modules 3 to allow data exchange between the hybrid hose assembly 100 and external computing devices 5.

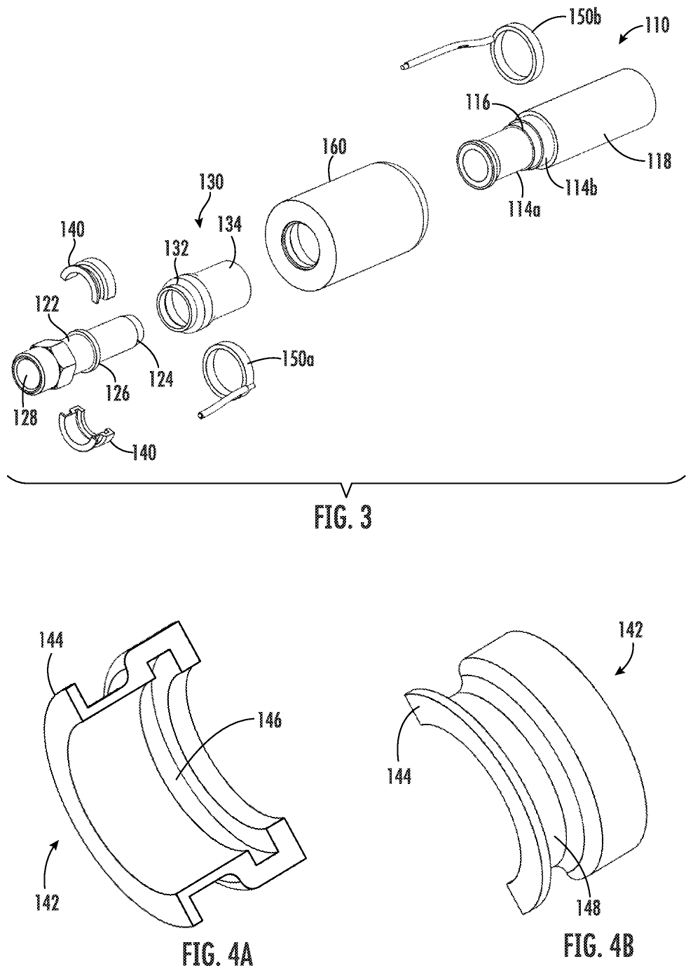

Finally, an overmold 160 (pictured in FIGS. 1 and 3) may surround the hose fitting 120 and adjacent end of the hybrid hose 110 to protect the electrically active connections and wires. The overmold 160 can be formed of Scotchcast™M or another electrical insulating resin that can adhere to the materials of this design and provide a robust, watertight seal. In other embodiments, an electrical receptacle could be embedded into the overmold 160 to facilitate removal. Viewing FIG. 1, the terminal ends of the bonded wires 152 and the working end 128 of the fitting body 122 protrude from the overmold 160 so that the operator may access these connection points. In another embodiment, transceiver module 3 could be incorporated into the overmold 160, and any connections between transceiver module 3 and computing device 5 would protrude from the overmold instead of the bonded wires 152.

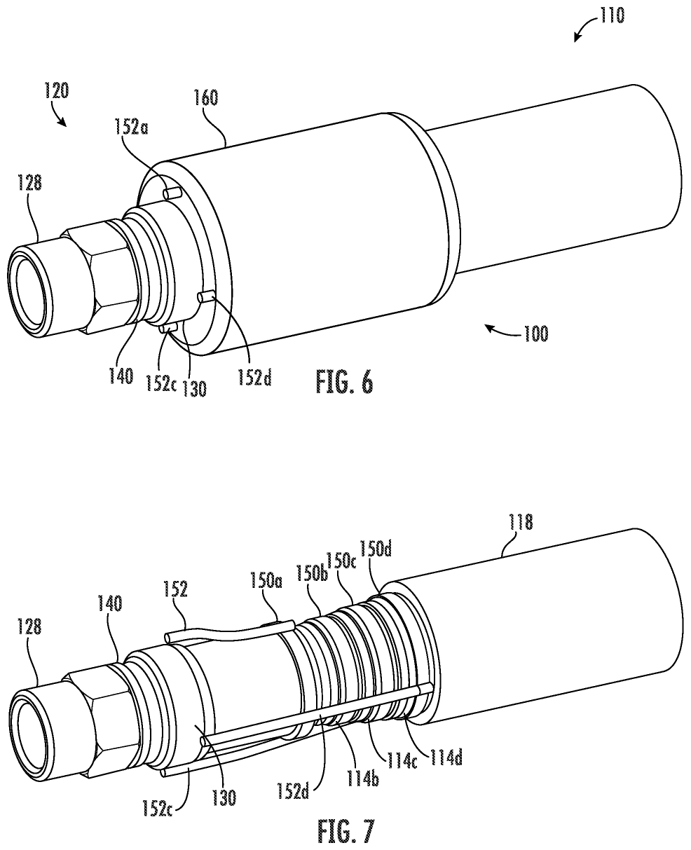

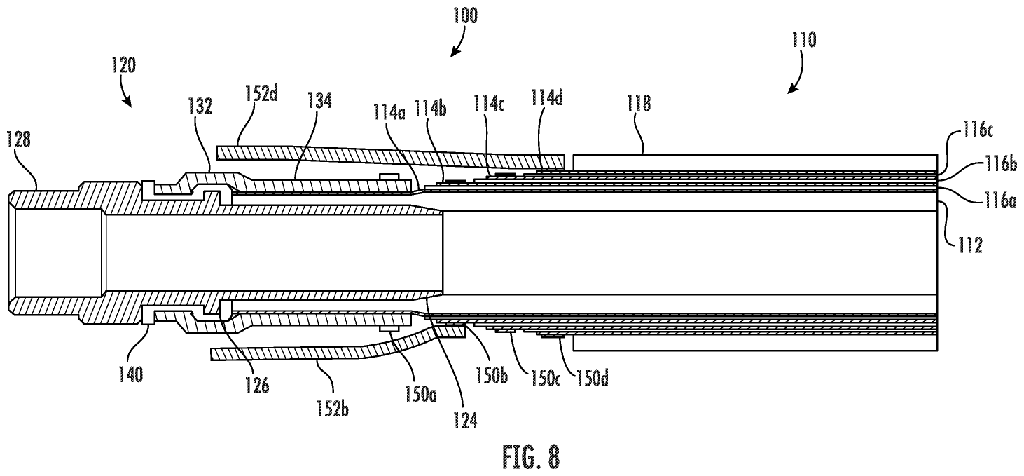

Because the exemplary embodiment of FIGS. 1-5 only uses two layers of conductive braids, this hose is more limited in the amount of data it can transmit. However, the design of hybrid hose assembly 100 is adaptable to more braid layers, providing the capability for high bandwidth data transmission. For example, FIGS. 6-8 illustrate hybrid hose assembly 100 with four braid layers 114. Viewing FIG. 8, each successive braid layer 114a, 114b, 114c, 114d and corresponding insulating separation layer 116 is shorter than the braid layer 114 below it, leaving a portion of each braid layer 114 exposed. Like in the embodiment pictured in FIGS. 1-5, the first metallic braid layer 114a is surrounded by the lower portion 134 of crimp collar 130, establishing an electrical connection. The exposed portions of each of the second 114b, third 114c, and fourth 114d braid layers are surrounded by braid contact bands 150b, 150c, 150d with bonded wires 152 to establish electrical connections with the braids 114. The remaining aspects of the design remain unchanged from the embodiment of FIGS. 1-5. Thus, hybrid hose assembly 100 is easily adapted to use additional or fewer braid layers depending on the desired bandwidth and weight limitations of the particular application.

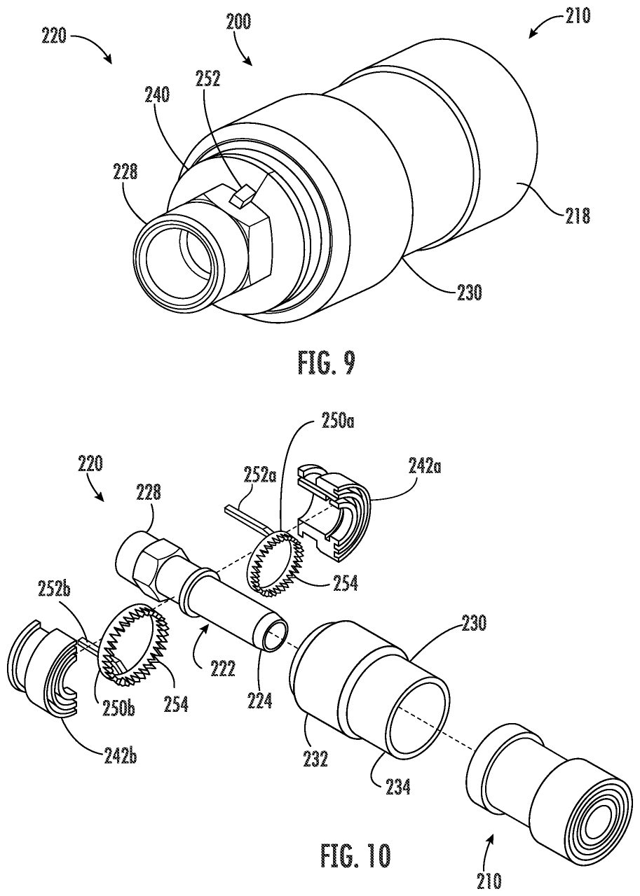

Referring now to FIGS. 9-14, a second embodiment of the hybrid fluid power hose assembly 200 is depicted. The hybrid hose 210 comprises: a core tube 212, a first layer of conductive metallic braids 214a, an insulating layer 216, a second layer of conductive metallic braids 214b, and then a protective jacket 218. Viewing FIGS. 10, 13 and 14, hose fitting 220 primarily comprises (1) a main fitting body 222 that is generally shaped like a hollow cylinder, (2) a crimp collar 230, (3) insulator 240, and (4) contact bands 250. Fitting body 222 comprises a tapered end 224 that fits inside the core tube 212 and a working end 228 that protrudes from the core tube 212. Fitting body 222 also comprises a retaining boss 226, which secures in place electrical insulator 240, which wraps around fitting body 222.

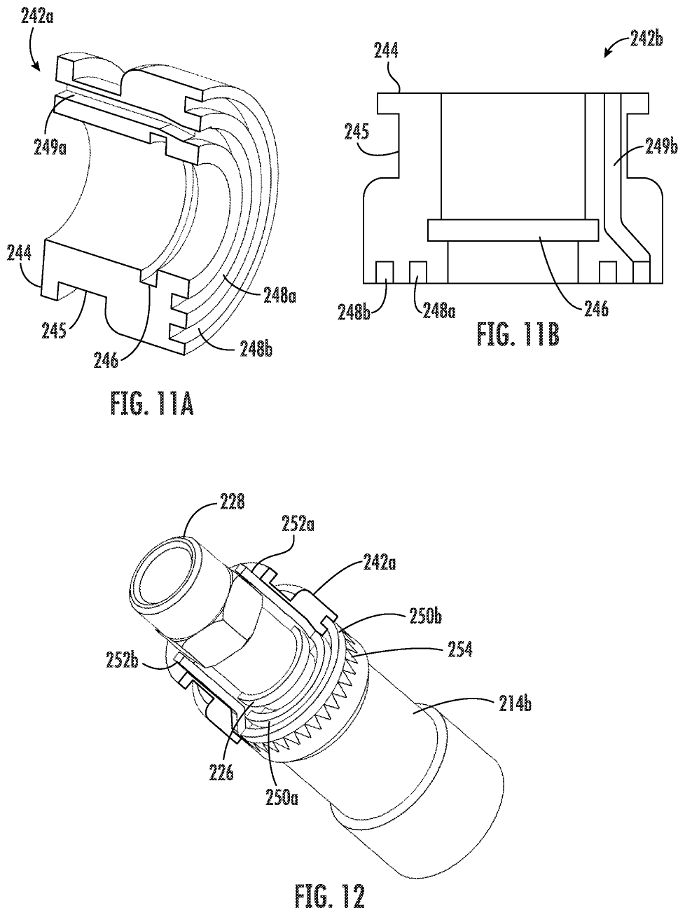

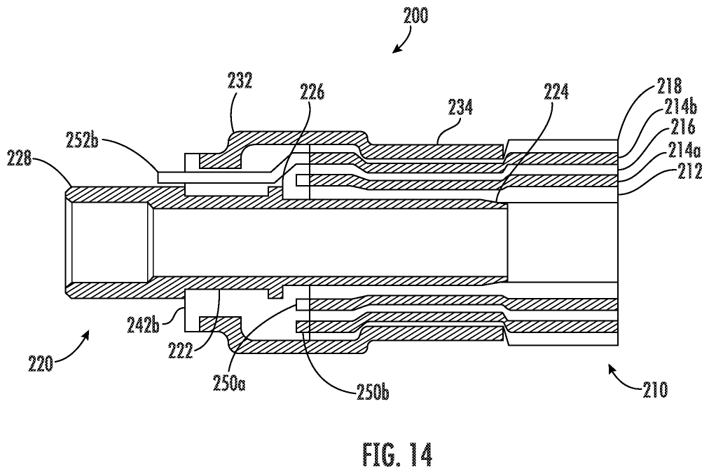

The electrical insulator 240 can be two c-shaped halves 242 that align to cover the entire circumference of the fitting body 222 when the insulator halves 242 are placed around the fitting body 222, but in other embodiments, the insulator 240 can be a single piece formed of an elastomeric material that can stretch around the fitting body 222 to be put into position. Turning to FIGS. 11a-11b, each c-shaped insulator half 242 comprises an internal retention groove 244 for retaining boss 226 of the hose fitting 220. The insulator halves 242 also comprise an upper lip 244, which forms an exterior pocket 245 in which the upper portion 232 of the crimp collar 230 sits when crimped over the insulator 240. The upper lip 244 ensures complete separation between the crimp collar 230 and the working end 228 of the fitting 220 (see FIG. 14). The insulator 240 should be made of a material with insulating properties and with a high compressive strength, such as Garolite™ or a phenolic resin, to withstand the crimping force and other forces applied to the fitting and crimp collar. The electrical insulator 240 described herein is merely exemplary of the myriad of different methods and materials, both known and developed in the future, which could be used to insulate the conductive elements of hose assembly 200.

The electrical connection of hybrid hose assembly 200 is established by barbed contact bands 250a, 250b (best seen in FIG. 10) used to electrically engage the ends of the braid layers 214a, 214b, which are the same length and thus do not have exposed portions as in hybrid hose assembly 100. Each contact band 250 must be precisely sized to be the same diameter as its corresponding braid layer 214, and the barbs 254 must be sufficiently sharp to penetrate into and engage the internal braids 214 of the hose 210. Each contact band 250 also comprises a conductive rod 252 that extends towards the working end 228 of fitting body 222. Because of their different diameters, first contact band 250a nests inside second contact band 250b (see FIG. 12).

Turning back to FIGS. 11a-11b, the contact bands 250a, 250b fit into specially formed grooves in c-shaped insulators 242a, 242b. In each insulator half 242a, 242b, first contact band 250a sits inside first band groove 248a, and second contact band 250b sits inside second band groove 248b. The conductive protrusions 252a, 252b travel through and protrude from passageways 249a, 249b in c-shaped insulators 242a, 242b that connect to the band grooves 248a, 248b. The protruding ends of the conductive rods 252a, 252b are accessible so that they may be soldered or welded to wires, connected to an electrical receptacle, or used in any other suitable configuration for electrical connectivity. In the embodiment pictured, which is designed for a hose 210 with two layers of braids 214a, 214b, the first insulator half 242a comprises the passageway 249a for the conductive rod 252a of first contact band 250a, while the second insulator half 242b houses the passageway 249b for the conductive rod 252b of second contact band 250b. However, in other embodiments comprising additional braid layers 214, each insulator half 242 may comprise additional band grooves 248 and multiple passageways 249 for additional conductive rods 252, as long as the band grooves 248 and passageways 249 are arranged inside insulator 240 such that the contact bands 250 and attached conductive rods 252 are completely insulated from each other.

Returning to FIG. 14, hose assembly 200 may use a crimp collar 230 to secure the hose 210 and insulator 240 to the fitting 220. An upper portion 232 of the crimp collar 230 compresses the c-shaped insulators 242 against the fitting body 222, and a lower portion 234 of the crimp collar 230 compresses the core tube 212, hose layers 214, insulating layers 216, and protective jacket 218 against the fitting body 222. No overmold is required in this design because the contact bands 250 and conductive rods 252 run between the hose fitting 222 and the crimp collar 230 instead of around the crimp collar 230 like in hybrid hose assembly 100. Although not pictured, this embodiment could also include third and fourth layers of conductive metallic reinforcement braids, separated by additional layers of insulating material, and connected to third and fourth contact bands. Further, other embodiments may combine elements of the hybrid hose assembly 100 and the hybrid hose assembly 200, having first braid layer extend out past the second braid layer and electrically engaged by the crimp collar, while subsequent braid layers are engaged by a barbed contact band.

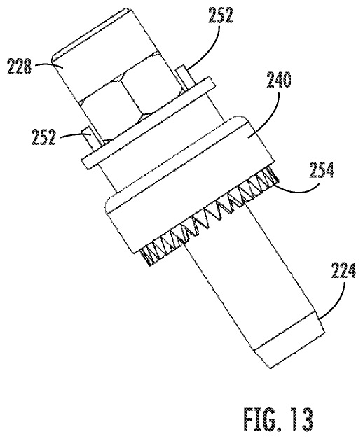

The design of hybrid hose assembly 200 is advantageous because it may be simpler to utilize in practice. Instead of skiving back hose layers to create exposed portions that must be individually wrapped with contact bands, the fitting 220 in this design may come with the barbed conductors 250 and electrical insulators 240 already installed, as shown in FIG. 13, so that all a field operator needs to do to install fitting 220 is mark the depth the fitting 220 needs to be hammered into place on hose 210, drive it onto the hose 210, then crimp it in place with crimp collar 230, which is all already standard field practice. Other envisioned embodiments of this fitting could employ an electrical receptacle integral to the fitting, further simplifying the fitting installation process.

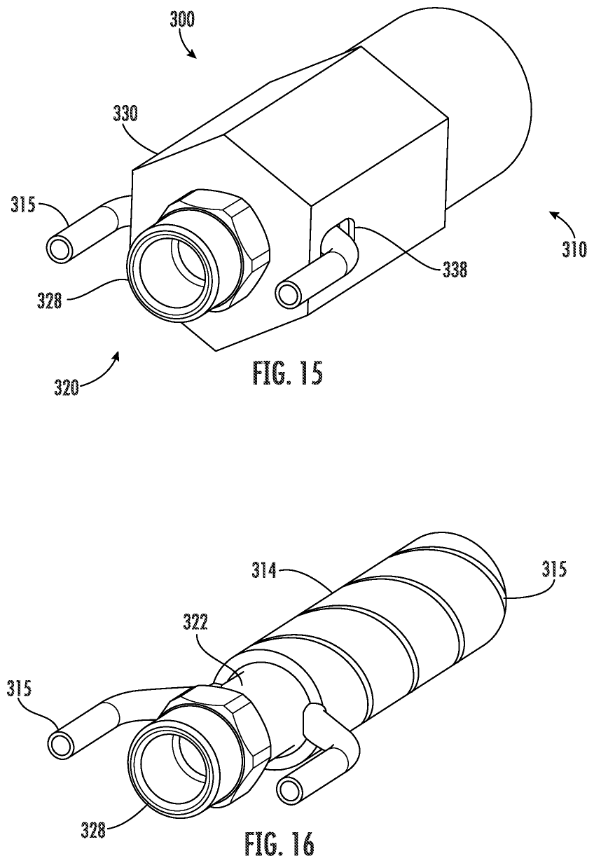

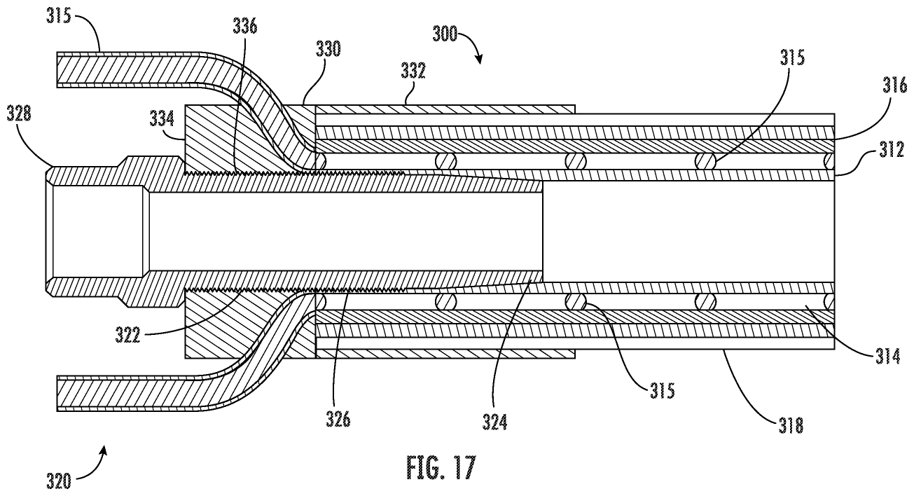

Referring now to FIGS. 15-17, a third embodiment of the hybrid hose assembly is depicted. Hybrid hose assembly 300 may comprise a hose 310 with, starting at the innermost layer: a core tube 312, an elastomeric insulating layer 314 embedded with conductive wires 315, reinforcement braids 316, and a protective jacket 318. Best shown in FIG. 16, the wires 315 may be embedded in the elastomeric layer 314 in a spiral pattern down the length of the hose 310, and the ends of the wires 315 protrude from hose 310 so they may be used for electrical connection. The exposed ends of the wires 315 may be covered in heat shrink tubing to protect and insulate them. Additional wires embedded separately from the first wires 315 may be added to increase the bandwidth of the hose assembly 300. Alternatively, another embodiment may incorporate an insulating layer with embedded wires into hybrid hose assemblies 100 or 200, allowing for additional bandwidth and/or fewer braid layers in those designs.

Still viewing FIG. 17, hybrid hose assembly 300 further comprises a hose fitting 320, which primarily comprises (1) a fitting body 322 shaped like a hollow cylinder and (2) a compression socket 330. Fitting body 322 comprises a tapered end 324 designed to fit inside core tube 312 and a working end 328 that protrudes from the core tube 312 and serves to complete the hydraulic or pneumatic fluid connection from the core tube 312 to an external device. The tapered end 324 comprises external threads 326. Hose 310 is secured to hose fitting 320 by compression socket 330, which comprises a hollow body 332, with a mouth 334 on one end comprising internal threads 336 designed to engage the external threads 326 of fitting 320. Compression socket 330 further comprises apertures 338 through which the ends of the conductive wires 315 can pass to engage a transceiver module 3 (see FIG. 15).

To install the fitting 320 on hose 310, the exposed ends of wires 315 are fed through apertures 338, and the compression socket 330 is hammered down on hose 310. Then, the fitting body 322 is threaded into the mouth 334 of compression socket 330 and into core tube 312 of the hose 310. As the fitting body 322 is threaded into compression socket 330, it expands hose 310 and compresses it against the inside of the hollow body 332 of compression socket 330. This type of fitting has the benefit of being reusable because it uses threading, as opposed to a crimp collar which must be permanently deformed into place. However, in alternative embodiments, a crimp collar and unthreaded hose fitting could also be used, so long as the crimp collar also had apertures for the conductive wires.

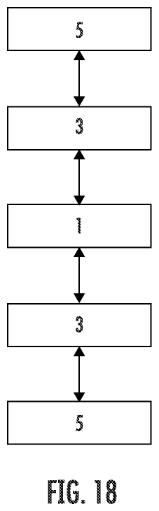

Referring now to FIG. 18, a process by which the hybrid hose assembly 1 of the present invention transmits electrical signals between computing devices 5 located at each end of the hybrid hose assembly 1 is depicted. At each of its ends, the hybrid hose assembly 1 connects to a transceiver module 3, which in turn connects to a computing device 5. In some embodiments, the transceiver module 3 may be incorporated into the hose assembly 1 itself, but in others it is external to the hose assembly 1. Data generated by a first computing device 5a can be digitally communicated to the first transceiver module 3a, which then modulates the data and sends it to the hose assembly 1. The conductive elements of the hose assembly 1 transmit the data through the hose to the second transceiver module 3b at the other end of the hose assembly 1. The second transceiver module 3b then demodulates the data and digitally communicates it to a second computing device 5b. Notably, the hybrid hose assembly 1 allows bidirectional communication between the two devices 5a, 5b, so data signals can be sent from the second computing device 5b to the first computing device 5a as well. The transceiver modules 3 and hose assembly 1 may use modulated communication via line coupling circuitry, such as G.hn communications module MaxLinear Wave-2 Eval kit, or any other similar modulated communication circuitry. The transceiver modules 3 and computing devices 5 may communicate with each other via ethernet, USB, Wi-Fi, RS232, RS485, SPI, or any other suitable digital connection.

### PROPHETIC EXAMPLES

The description which follows, and the embodiments described therein, is provided by way of illustration of examples of particular embodiments of principles and aspects of the present invention. These examples are provided for the purposes of explanation—and not of limitation—of those principles of the invention.

### Example 1

The hybrid hose assembly 1 may be particularly suited for use in high pressure environments, such as in trenchless applications. For example, if used in impact moling, as shown in FIG. 19, hybrid hose assembly 14 may be used to connect impact mole 12 to a surface controller 16. In this exemplary application, the impact mole 12 may comprise a steering actuator and a displacement sensor, and the surface controller 16 may simultaneously transmit hydraulic or pneumatic power to the impact mole 12, transmit electric power and steering commands to the steering actuator, and receive location signals from the displacement sensor. In one example, the steering actuator may be a hydraulic tensioning unit configured to rotate a tapered steering head when torque is applied to the tensioning unit, thereby steering the impact mole 12. The displacement sensor may be an inertial measurement unit (IMU) or any other suitable displacement sensor. During impact moling, the operator positions the impact mole 12 in a subterranean bore, and then uses the surface controller 16 to transmit steering commands through the hybrid hose assembly 14 to the steering actuator in order to drive the impact mole 12 along an intended path. As the impact mole 12 digs through the ground, the surface controller 16 will receive location signals from the displacement sensor through the hybrid hose assembly 14 so that the operator can determine whether the impact mole 12 is progressing along the intended path. Additionally, the surface controller 16 may also report an impedance change in the data signals sent through the hybrid hose assembly 14 to warn the operator of damage to the hose.

### Example 2

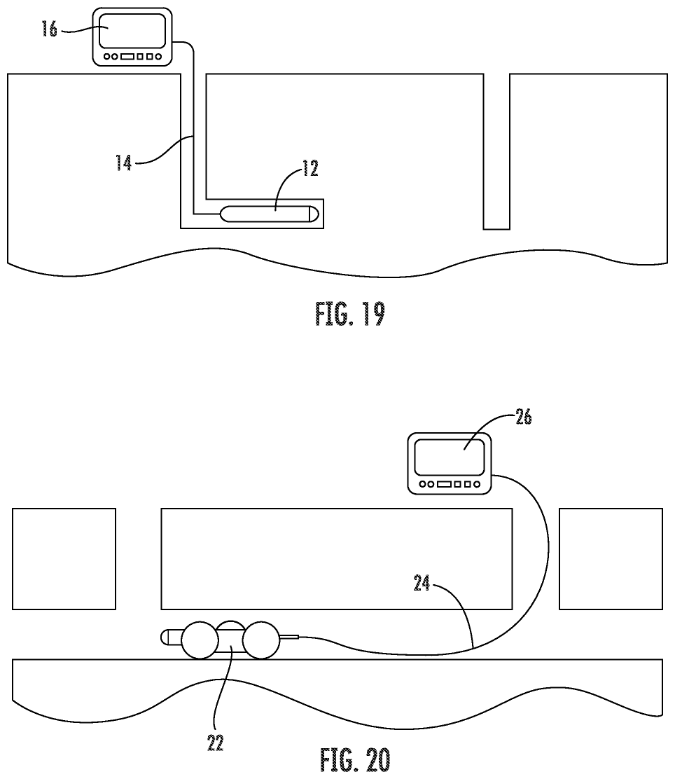

In another exemplary application depicted in FIG. 20, the hybrid hose assembly 24 may be used to connect a surface controller 26 to a submersible robotic crawler system 22 in order to conduct sewer inspection and rehabilitation. The robotic crawler system 22 may comprise one or more peripheral tools, such as a jetting machine, a hydro-jetting hose, a descaling machine, a concrete/shotcrete nozzle, a lateral liner reinstatement robot, a chemical grouting robot, a liner installation robot, or any other robot tool combination that benefits from pneumatic or hydraulic power supplied by a hybrid hose assembly 24. The robotic crawler system 22 may further include a steering actuator and displacement sensor, allowing the operator to use the hybrid hose assembly 24 to send electric power and steering command signals from the surface controller 25 to the steering actuator to steer the robotic crawler 22 along an intended path and simultaneously send location signals from the displacement sensor to the surface controller 26 to determine whether the robotic crawler 22 is proceeding along the intended path. The robotic crawler system 22 may further comprise a camera, a light to illuminate the camera's view, a camera orientation actuator, and a cameral displacement sensor. The camera could be an axial camera, a self-leveling camera, a 360-degree camera, a pan-tilt-zoom camera, a camera array, or any other camera combination preferentially arranged to allow visual inspection of the pipeline and supervision of repair progress. The operator may use the surface controller 26 to receive and display video feed sent from the camera through the hybrid hose assembly 24. The operator may then send commands from surface controller 26 through the hybrid hose assembly 24 to the camera orientation actuator to pan, tilt, zoom, adjust camera settings, adjust lighting, start and stop recording, or control any other camera operations. At the same time, the camera displacement sensor can send orientation data back to the surface controller 26 through the hybrid hose assembly 24 so that the operator can ensure the commands sent to the camera are being followed. Further, the robotic crawler system may comprise one or more inspection sensors, such as an Inertial Measurement Unit, a LiDAR sensor, a structured light system, a sonar device, a radar and ultrasonic sensor, an environmental monitoring system, and/or any other inspection sensor that could be utilized in pipeline inspection and remediation. The hybrid hose assembly 24 can transmit command signals from the surface controller 26 to the inspection sensor(s) 22 in order to collect inspection data and then send the captured data back to the surface controller 26 to collect environmental information about the pipeline.

Many modifications and other embodiments of the inventions set forth herein will come to mind to one skilled in the art to which these inventions pertain having the benefit of the teaching presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A trenchless boring method comprising the steps of:
a) providing a boring system comprising:
(i) a boring head including: (1) a steering actuator and (2) a displacement sensor;
(ii) a surface controller configured to (1) transmit steering signals to the steering actuator and (2) receive location signals from the displacement sensor; and
(iii) a fluid power hose assembly comprising (1) a core tube, (2) at least two layers of conductive, metallic braids, (3) an insulating layer separating the conductive braids, and (4) a protective jacket;
(iv) wherein (1) the core tube is configured to transmit fluid power to the boring head, and (2) the conductive braids are configured to transmit electric power to the steering actuator and location signals to the surface controller;
b) positioning the boring head in a subterranean bore;
c) transmitting steering signals from the surface controller to the steering actuator, through the fluid power hose assembly, in order to drive the boring head along an intended path; and
d) receiving location signals at the surface controller in order to determine whether the boring head is progressing along the intended path.

2. The method of claim 1, wherein the boring head is a pneumatic piercing tool.

3. The method of claim 1, wherein the steering actuator comprises a fluid-powered tensioning unit configured to rotate a tapered steering head when torque is applied to the tensioning unit, thereby steering the boring head.

4. The method of claim 1, wherein the steering signals and the location signals are encoded prior to being transmitted across at least one of the conductive braids using either standard narrow band telecommunication protocols or wide band communication protocols.

5. The method of claim 1, wherein the boring head bores at a depth of less than 50 feet below surface level.

6. The method of claim 1, wherein hose damage is detected by an impedance change in the data signals during transit.

7. A trenchless pipeline inspection and rehabilitation method comprising the steps of:
a) providing a robotic crawler system comprising:
(i) a robotic crawler including: (1) a camera orientation actuator, (2) a camera, and (3) a fluid-powered peripheral tool;
(ii) a surface controller configured to (1) transmit command signals to the camera orientation actuator, (2) receive and display video feed from the camera, and (3) operate the peripheral tool; and
(iii) a fluid power hose assembly comprising (1) a core tube, (2) at least two layers of conductive, metallic braids, (3) an insulating layer separating the conductive braids, and (4) a protective jacket;
(iv) wherein (1) the core tube is configured to transmit fluid power to the peripheral tool, and (2) the conductive braids are configured to transmit electric power to the camera and the camera orientation actuator, video feed to the surface controller, and command signals to the peripheral tool.
b) positioning the robotic crawler in a subterranean pipeline;
c) transmitting command signals from the surface controller to the camera orientation actuator, through the fluid power hose assembly, in order to pan, tilt, zoom, adjust camera settings, adjust lighting, start and stop recording, or control any other camera operations;
d) transmitting command signals from the surface controller to the peripheral tool; and
e) receiving a high-definition video feed through a high bandwidth link at the surface controller in order to visually inspect the pipeline for damage and to monitor repair progress.

8. The method of claim 7, wherein the robotic crawler further comprises a camera displacement sensor; the conductive braids are further configured to transmit orientation signals to the surface controller, and the surface controller is further configured to receive orientation signals from the camera displacement sensor.

9. The method of claim 8, further comprising the step of receiving orientation signals at the surface controller in order to determine the positioning of at least one of the camera and the fluid-powered peripheral tool.

10. The method of claim 7, wherein the orientation signals and the location signals are encoded prior to being transmitted across at least one of the conductive braids using either standard narrow band telecommunication protocols or wide band communication protocols.

11. The method of claim 7, wherein the camera is one of an axial camera, a self-leveling camera, a 360° camera, Pan Tilt Zoom Camera, or Camera Array.

12. The method of claim 7, wherein the robotic crawler further comprises a light to illuminate the camera's line of vision.

13. The method of claim 7, wherein the peripheral tool is one of a jetting machine, a hydro-jetting hose, a descaling machine, a concrete/shotcrete nozzle, Lateral Liner Reinstatement Robot, a Chemical Grouting Robot, a Liner Installation Robot, or any other robot tool combination that benefits from fluid power supplied by a hose.

14. The method of claim 7, wherein the robotic crawler further comprises an inspection sensor; the conductive braids are further configured to transmit inspection data to the surface controller, and the surface controller is further configured to receive and display inspection data from the inspection sensor.

15. The method of claim 14, further comprising the steps of:
a) transmitting control signals from the surface controller to the inspection sensor, through the fluid power hose assembly, in order to collect inspection data; and
b) receiving and displaying inspection data at the surface controller in order to collect environmental information about the pipeline.

16. The method of claim 14, wherein the inspection sensor is one of an inertial measurement unit, a LiDAR sensor, a structured light system, a sonar device, a radar and ultrasonic sensor, an environmental monitoring system, or any other inspection sensor that can be utilized on the same communication channel.

17. The method of claim 7, wherein the robotic crawler system is submersible.

18. The method of claim 7, wherein
a) the robotic crawler further comprises (4) a steering actuator and (5) a displacement sensor;
b) the conductive braids are further configured to transmit electric power to the steering actuator and location signals to the surface controller; and
c) the surface controller is further configured to (4) transmit steering signals to the steering actuator and (5) receive location signals from the displacement sensor.

19. The method of claim 18, further comprising the steps of:
a) transmitting steering signals from the surface controller to the steering actuator, through the fluid power hose assembly, in order to drive the robotic crawler along an intended path; and
b) receiving location signals at the surface controller in order to determine whether the robotic crawler is progressing along the intended path.

20. A fluid power hose assembly comprising:
a) a fluid power hose comprising:
(i) a core tube;
(ii) at least three layers of conductive metallic braids, comprising a first, second, and third conductive braid layer, wherein each successive braid layer includes an exposed end offset from an exposed end of the previous braid layer;
(iii) insulating layers that separate the braid layers; and
(iv) a protective jacket;
b) a hose fitting comprising:
(i) a fitting body;
(ii) a crimp collar, comprising an upper portion and a lower portion;
(iii) an electrical insulator situated between the upper portion of the crimp collar and the fitting body; wherein the lower portion of the crimp collar compresses an innermost, first braid layer and core tube against the fitting body, to create an electrical connection between the first braid layer and the collar; and
(iv) braid contact bands with bonded wires, wherein a first contact band creates an electrical connection with the lower portion of the crimp collar, and second and third contact bands create electrical connections with the second and third braid layers respectively, thereby allowing electrical communication through each braid layer to its respective bonded wire; and
c) an overmold covering the contact bands.

21. The fluid power hose assembly of claim 20, wherein the fitting body comprises a tapered end that sits inside the core tube and a boss that holds the insulator in place around the fitting body.

22. The fluid power hose assembly of claim 20, wherein the contact bands are copper, bronze, aluminum, or some other electrically conductive material.

23. The fluid power hose assembly of claim 20, wherein the crimp collar is crimped on the upper portion to affix itself and the insulator to the fitting body.

24. The fluid power hose assembly of claim 23, wherein the crimp collar is crimped on the lower portion to affix the hose fitting to the fluid power hose.

25. The fluid power hose assembly of claim 20, wherein the insulator comprises two c-shaped insulators align to cover an entire circumference of the fitting body when the insulators are placed around the fitting body.

26. The fluid power hose assembly of claim 20, wherein the fluid power hose further comprises a fourth conductive braid layer; wherein the hose fitting further comprises a fourth contact band with a bonded wire; and wherein the fourth contact band creates an electrical connection with the fourth braid layer, thereby allowing electrical communication through the fourth braid layer to the bonded wire.

27. A fluid power hose assembly comprising:
a) a fluid power hose comprising: a core tube, a first and second layer of conductive metallic braids, an insulating layer between the conductive braids, and a protective jacket; and
b) a hose fitting comprising:
(i) a fitting body;
(ii) contact bands with bonded wires, wherein the contact bands comprise barbs that wedge into the braids to create an electrical connection between the braids and the bonded wires;
(iii) a crimp collar, comprising an upper portion and a lower portion; and
(iv) an insulator seated between the fitting body and crimp collar, wherein the insulator separates the copper bands and bonded wires from the fitting body and crimp collar.

28. The fluid power hose assembly of claim 27, wherein the crimp collar is crimped on the upper portion to affix itself and the insulator to the fitting body.

29. The fluid power hose assembly of claim 28, wherein the crimp collar is crimped on the lower portion to affix the hose fitting to the fluid power hose.

30. The fluid power hose assembly of claim 27, wherein the insulator comprises two c-shaped insulators that align to cover an entire circumference of the fitting body when the insulators are placed around the fitting body.

31. The fluid power hose assembly of claim 27, wherein the fitting body comprises a tapered end that sits inside the core tube and a boss that holds the insulator in place around the fitting body.

32. The fluid power hose assembly of claim 27, wherein the contact bands are copper, bronze, aluminum, or some other electrically conductive material.

33. A fluid power hose assembly comprising a fluid power hose, wherein the fluid power hose comprises:
a) a core tube;
b) an elastomeric insulating layer, wherein the insulating layer is embedded with at least one pair of conductive wires, wherein the conductive wires are configured to transmit data signals, electric power, or a combination thereof;
c) at least one layer of reinforcement braids; and
d) a protective jacket;

34. The fluid power hose of claim 33, wherein the conductive wires are wrapped in a spiral pattern around the core tube.

35. The fluid power hose assembly of claim 33, wherein the reinforcement braids are nonmetallic.

36. The fluid power hose assembly of claim 33, further comprising a hose fitting configured to establish an electrical connection between the fluid power hose and a peripheral device, wherein the hose fitting comprises: a threaded fitting body and a compression socket.

37. The fluid power hose assembly of claim 36, wherein the compression socket further comprises apertures through which the conductive wires of the core tube can pass.

38. The fluid power hose assembly of claim 36, wherein the fitting body is configured to expand the core tube to compress the hose assembly when it is threaded into the compression socket.

39. The fluid power hose assembly of claim 33, further comprising a hose fitting configured to establish an electrical connection between the fluid power hose and a peripheral device, wherein the hose fitting comprises: a hose fitting body and a compression collar.

40. The fluid power hose assembly of claim 39, wherein the compression collar further comprises apertures through which the conductive wires of the core tube can pass.
